(19) United States
(12) Patent Application Publication
(10) Pub. No.: US 2008/0016831 A1
(43) Pub. Date: Jan. 24, 2008

(54) Dust bag positioning cylindrical member for a two-stage dust collecting machine

(76) Inventors: Chieh-Yuan Cheng, Taichung (TW); William Crofutt, Everson, WA (US)

Correspondence Address: TROXELL LAW OFFICE PLLC, 5205 LEESBURG PIKE, SUITE 1404, FALLS CHURCH, VA, 22041, US

(21) Appl. No.: 11/490,056

(22) Filed: Jul. 21, 2006

(51) Int. Cl. B01D 50/00

(52) U.S. Cl. 55/337

(57) ABSTRACT

A dust bag positioning cylindrical member for a two-stage dust collecting machine is a cylindrical shape with an open upper end and an open lower end with a diameter a little less than that of a bag cylinder so that the dust bag positioning cylindrical member may be placed in and stabilize a dust bag previously placed in the bag cylinder. Thus the dust bag may not be blown to stick at the mouth of a first air exit during a second stage of dust collecting operation of the machine.

### BACKGROUND OF THE INVENTION

1. Field of the Invention

This invention related to a dust bag positioning cylindrical member for a two-stage dust collecting machine, particularly to one to be placed in a dust bag for stably positioning the dust bag in a bag cylinder of a two-stage dust collecting machine.

2. Description of the Prior Art

A conventional two-stage dust collecting machine shown in FIG. 1 includes a fan housing 11, a first air exit 111 in a lower end of the fan housing 11, a second exit 112 in an upper portion of the fan housing 11, a air inlet 113 in an intermediate portion of the fan housing 11, a motor 12 fixed on the fan housing 11 and a fan 13 just at the upper end of the fan housing 11 and connected and rotating with the shaft of the motor 12. When the motor 12 is started to rotate the fan 13, wind generated by the fan 13 will suck dust from the air inlet 113 into the fan housing 111. But dust of rather heavy or a large dimensions may fall through the fist air exit 111 into a dust bag 15 placed in the bag cylinder 14, which means the first round of dust collecting opeation. Then powder dust and smaller bits of wood waste may be blown by the wind to flow up and pass through a windpipe 16 into the second air exit 112 and then in the dust bag 17, which means the second round of dust collecting operation.

However, as shown in FIG. 1, when the two-stage dust collecting machine begins to operate, the motor 12 rotates the fan 13, which generates wind and sucking force to suck in dust from the air inlet 113 at the side wall of the fan housing 11, and carrying out a first round of dust collecting operation to remove rather heavy dust, with power dust and smaller bits wood waste to be sucked to flow through the windpipe 16 for a second dust collecting work. So it is clear that the windpipe 16 and the first air exit 112 communicate with each other, so the dust bag 15 may be prone to be sucked by the wind generated by the fan 13 to stick at the mouth of the first air exit 111, clogging the mouth to cause damage to the machine 10.

### SUMMARY OF THE INVENTION

The feature of the invention is a dust bag positioning cylindrical member to be placed in a dust bag to be placed in a bag cylinder, and the dust bag positioning cylindrical member is shaped a hollow cylinder with an open upper side and an open lower side having some weight to resist against the sucking force of the wind generated by the fan to keep the dust bag from sucked to stick at the mouth of the first air exit, avoiding damage possibly caused by sealing the mouth of the first air exit by the dust bag as does the conventional two-stage dust collecting machine. Further, the diameter of the dust bag positioning cylindrical member is a bit smaller than that of the bag cylinder to hold the dust bag stably in the bag cylinder.

### BRIEF DESCRIPTION OF DRAWINGS

This invention will be better understood by referring to the accompanying drawings, wherein:

FIG. 1 is a side cross-sectional view of a conventional two-stage dust collecting machine;

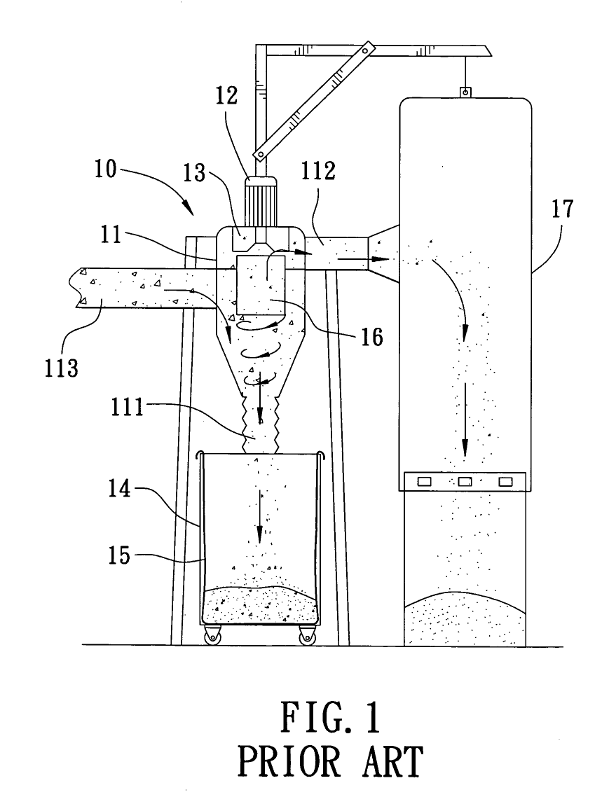

FIG. 2 is a side cross-sectional view of a two-stage dust collecting machine with a dust bag positioning cylindrical member in the present invention;

FIG. 3 is a perspective view of the dust bag positioning cylindrical member for a two-stage dust collecting machine in the present invention;

FIG. 4 is an exploded perspective view of a dust bag cylinder in the present invention; and,

FIG. 5 is a side cross-sectional view of the dust bag cylinder in the present invention.

### DETAILED DESCRIPTION OF THE PREFERRED EMBODIMENT

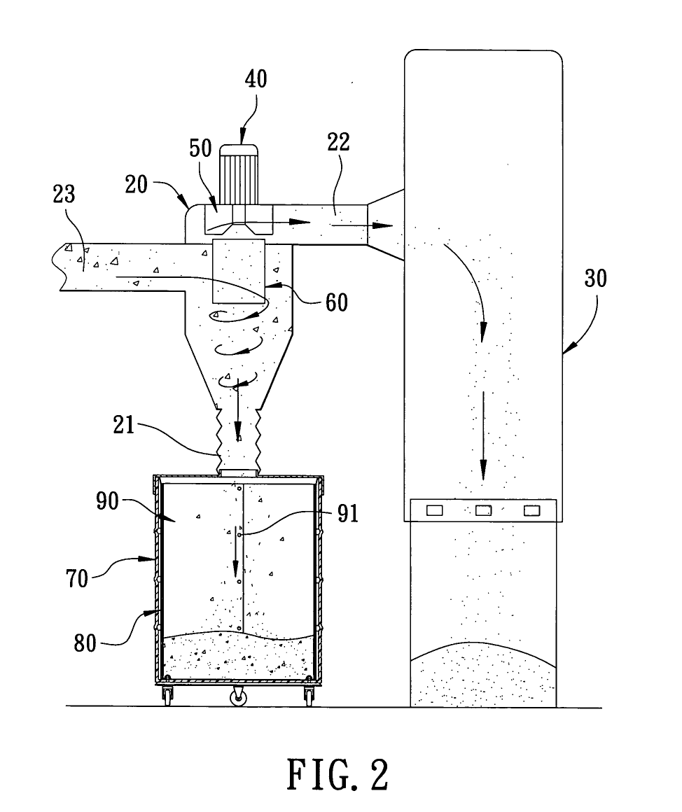

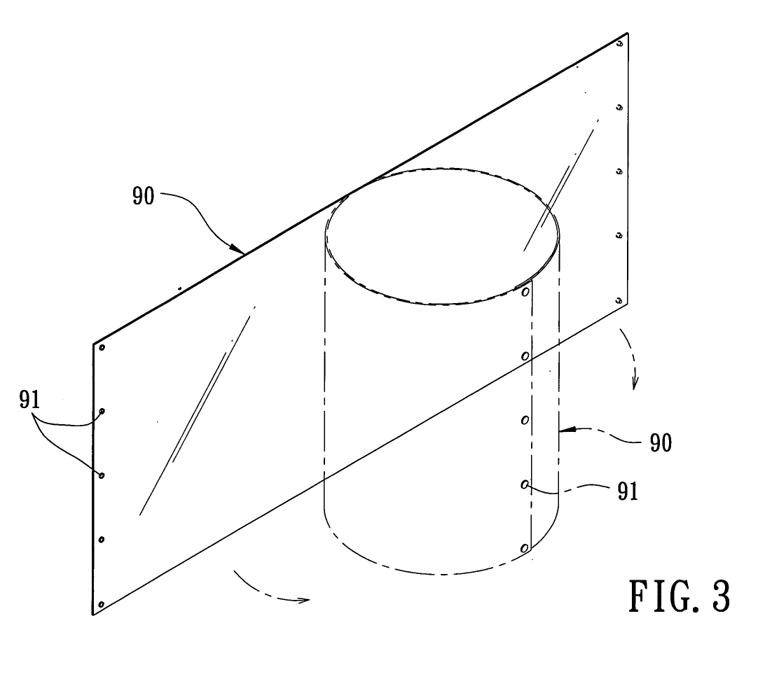

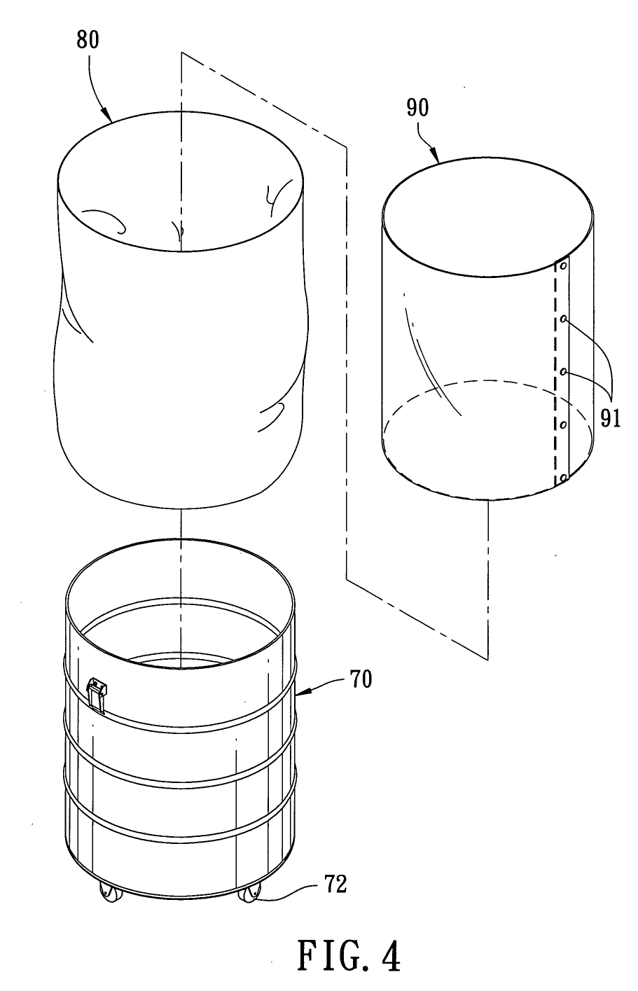

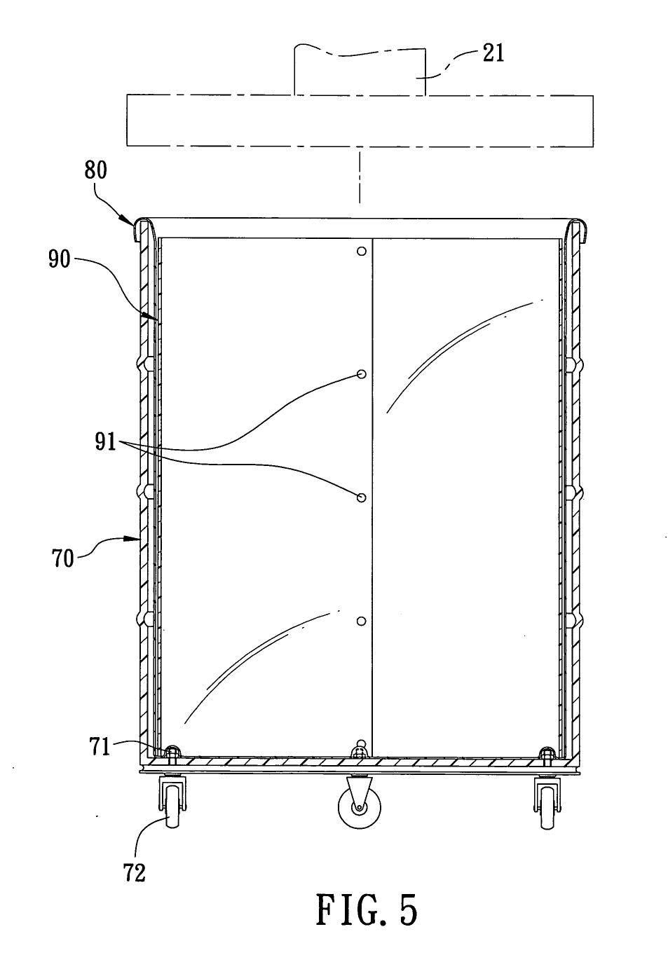

A preferred embodiment of a dust bag positioning cylindrical member for a two-stage dust collecting machine in the present invention as shown in FIGS. 2-5, is to be placed in a dust bag, which is to be placed in a bag cylinder of a two-stage dust collecting machine, which has almost the same structure as the conventional two-stage dust collecting machine described above, including a fan housing 20, a first air exit 21 in a lower end of the fan housing 20, a second air exit 22 in one side of the fan housing 20 and an air inlet 23 in the other side of the fan housing 20, a dust bag 30 connected to the second exit 22 for collecting powder dust or smaller bit of wood waste in a second stage of dust collecting opeation. Further, a motor 40 is installed on the fan housing 20, and a fan 50 is installed in the fan housing 20 and connected to the shaft of the motor 40 for generating wind. A windpipe 60 is provided under the fan 50 in the fan housing 20 for guiding powder dust and smaller bits of wood waste to the second air exit 22. The first air exit provided at the lower end of the fan housing 20 is connected to a bag cylinder 70 for the first stage of dust collecting operation to let rather heavy dust fall down therein. In order to enable the bag cylinder 70 to move around, plural casters 72 are attached under the lower surface of the bag cylinder 70 with threaded rods 71.

The difference of the present invention from the conventional machine is a bag positioning cylindrical member 80 to be placed in the dust bag 80, formed with a flexible plastic plate rolled to shape as a cylinder with an open upper end and an open lower end and kept in the cylindrical shape with fixing members 91 set at two lateral ends, which can be pressing buttons, so as to quickly shape up the bag positioning cylindrical member 80 with a diameter a little less than that of the bag cylinder 70 to stabilize the dust bag 80 previously placed therein, without disadvantaged possibility of being sucked to seal up the mouth of the first air exit 21.

The invention has the following advantages as can be seen from the foresaid description.

1. The dust bag positioning cylindrical member is formed with a flat flexible plastic plate to be easily rolled to shape up the cylindrical shape and kept in that shape with the fixing members, and it can be unrolled back to become the original flat plate for conveniently storing it away.

2. The bag positioning cylindrical member has a little less diameter than that of the bag cylinder so it can stabilize the dust bag in the bag cylinder to resist the sucking force of the wind generated by the fan, avoiding the dust bag to seal up the mouth of the first air exit to cause damage to the two-stage dust collecting machine.

3. The bag positioning cylindrical member can be repeatedly used by taking it out in case of the dust bag filled with dust and putting it therein again after the new bag is placed, very economical.

While the preferred embodiment of the invention has been described above, it will be recognized and understood that various modifications may be made therein and the appended claims are intended to cover all such modifications that may fall within the spirit and scope of the invention.

What is claimed is:

1. A dust bag positioning cylindrical member for a two-stage dust collecting machine, said collecting machine comprising a fan housing, said fan housing provided with an air inlet formed at one side, a first air exit formed in a lower end and a second air exit formed in the other side connected to and communicating with a dust bag, a bag cylinder fixed under said first air exit, said dust bag placed in said bag cylinder, dust sucked by wind generated by a fan in said fan housing and rotated by a motor, the wind blowing through said air inlet and then through said first air exit to flow into said dust bag placed in said bag cylinder to carrying out a first stage of dust collecting operation, said dust bag positioning cylindrical member made of a hollow cylindrical member with a diameter a little less than that of said bag cylinder so that said dust bag positioning cylindrical member may be placed in said dust bag for stabilizing said dust bag in said bag cylinder.

2. The dust bag positioning cylindrical member for a two-stage dust collecting machine as claimed in claim 1, wherein said dust bag positioning cylindrical member is formed with a flexible flat rectangular plastic plate, which is rolled to be shaped cylindrical, having two lateral ends respectively provided with plural fixing members that can be fixed with one another to keep the rolled cylindrical shape and also can be released to let the cylindrical shape recovered back to the flat shape.

3. The dust bag positioning cylindrical member for a two-stage dust collecting machine as claimed in claim 1, wherein said fixing members are pressing buttons
